(19) United States
(12) Patent Application Publication
(10) Pub. No.: US 2005/0087107 A1
(43) Pub. Date: Apr. 28, 2005

(54) Building and other materials containing treated bauxite tailings and process for making same

(76) Inventor: Charles D. Jaquays, Christiansted, VI (US)

Correspondence Address: Donald A. Kettlestrings, Esq., Suite 211, 414 Hungerford Drive, Rockville, MD, 20850, US

(21) Appl. No.: 10/690,729

(22) Filed: Oct. 23, 2003

(51) Int. Cl. C04B 7/00; B01F 1/00; C01F 1/00; C01F 3/00; C01F 7/20; B01D 11/00; C01G 15/00

(52) U.S. Cl. 106/638; 423/131; 423/132; 423/201; 423/202

(57) ABSTRACT

A process and product are described whereby a waste stream containing bauxite tailings is treated to neutralize alkaline material present, and the resulting material incorporated, for example, into building or other materials to provide enhanced properties.

### CROSS-REFERENCE TO RELATED APPLICATIONS

This application hereby claims priority benefits under 35 USC 365 based on international patent application serial number PCT/US02/12490, filed under the Patent Cooperation Treaty in the United States Patent and Trademark Office on Apr. 23, 2002 and on U.S. Provisional Application Ser. No. 60/287,669, filed May 2, 2001.

### BACKGROUND OF THE INVENTION

1. Field of the Invention

This invention relates to a process for treating waste streams containing bauxite tailings to neutralize alkali metal hydroxide present, such as sodium hydroxide to obtain a product that can be incorporated into building or other materials, such as bricks to enhance their properties. The invention further relates to enhanced building materials containing tailing material treated in accordance with the process of the invention.

2. Description of the Related Art

The Bayer process for alumina production from bauxite results in the formation of large quantities of “red mud” or tailings, which are both a source of pollution and a waste of a potentially valuable mineral resource. It would, accordingly, be advantageous to have a process which efficiently utilizes these tailings as a useful industrial product.

U.S. Pat. No. 3,985,567 to Iwu describes a process for combining treated bauxite tailings with clay and heating in an oven to obtain a brick product.

U.S. Pat. No. 4,133,866 to Lokatos et al. describes a process for separating bound sodium from red mud residue in which ferric sulfate is used to extract the sodium content.

U.S. Pat. No. 5,554,352 to Jaques et al. describes treating virgin bauxite to produce pozzolan for use in concrete products.

### BRIEF SUMMARY OF THE INVENTION

In accordance with the present invention, a process is provided for treating waste streams containing bauxite tailings to render them suitable for incorporation into useful construction materials, such as bricks, that are formed from cementitious material. The invention further provides an improved building material in which bauxite tailings which have been treated with a mineral acid to neutralize alkali metal hydroxides which can then be combined with a cementitious material and cured to provide a superior construction material. Prior to combining with cementitious or other material, water and all or a portion of the alkali metal salts formed by the neutralization are removed.

### DETAILED DESCRIPTION OF THE INVENTION

Initially, in accordance with the invention, bauxite tailings are commuted to a homogenous powder that can pass through a 1/16″ or smaller screen mesh, and water is added to the tailings. The addition of the water takes place while vigorously agitating the mixture. Sufficient water is added so that the slurry will flow freely and uniformly. The desired consistency and viscosity is approximately that of non-gelatinous house paint. Once this consistency is reached, an acid is added to the slurry in sufficient quantity, (i.e. 1 molar weight of hydrogen for each mole of sodium present in the tailings) during the agitation procedure, thereby stripping the sodium atoms from their hydroxyl ions. Whereupon a hydrogen atom from the acid exchanges positions with a sodium atom from the caustic soda (sodium hydroxide) and forms water. The sodium ion takes up the vacancy left by the hydrogen atom to form a salt by-product. The specific salt is determined by the original mineral acid used, e.g. sulfuric acid would form sodium sulfate, hydrochloric acid would form sodium chloride. These salts are in solution and the slurry is separated either by centrifuge or by “slaking” or by any other means available. The salts are then separated from the water by distillation, or any other means, so that the water can be recycled to continue the process and the salts sold as industrial chemicals.

It should be noted at this point that there are secondary and tertiary reactions that can and will take place when the acid is added to the somewhat basic slurry. It is for this reason that it is preferred to have as fine a slurry as practicable under the prevailing circumstances and that the fine slurry is in a state of vigorous agitation at the moment of the intromission of an acid, the purpose of which is to diminish the reaction time or, the “time until exposure” of the acid to the target compound (sodium hydroxide). Inevitably, some potassium, magnesium and aluminum as well as other elements will be caught up in the process, but not enough in these circumstances to inhibit the goal, which is to remove the sodium hydroxide from the bauxite tailings so that the tailings can then be stabilized and subsequently incorporated into the matrix of common building materials.

Once the slurry has been separated from the salt solution, it is then ready to be utilized as a component in common building materials, such as paver bricks. By way of example, the proportions of the individual components of the aggregate are the same as would be used for a “normal” paver brick except that the “stabilized bauxite tailings” are used in place of any 200 mesh fines that would normally be present. If they (200 mesh fines) are not used, then “stabilized bauxite tailings” would be added to the mixture at the proportion of about 20% by volume. In this instance, the best mode of forming the finished product is currently the industry standard process of utilizing hydraulic compaction in conjunction with simultaneous vibrational compaction during the forming process of the premixed aggregate.

The apparatus for making the concrete brick can have at least one visible surface having a “finished” face. The brick may be made by filling a mold with concrete mixture, vibrating the mold, and using a descending plunger to compress the concrete in the filled mold. At least one interior surface of the mold can have a textured surface used to form the texture in the brick. Following compression of the mixture, a movable sidewall of the mold is moved laterally away from the brick a distance sufficient for the textured surface of the mold wall to clear the textured surface of the brick when the mold is raised. In the case of a paver brick, the finished face would be formed by the plunger. With the plunger remaining in place, the mold is raised, following which, the plunger is raised, yielding the finished brick.

Once formed, the bricks should preferably be kept in a super saturated humidity environment and the bricks themselves should not be allowed to become “dry” during the first 168 hours of curing. The moisture levels can be maintained by housing the finished bricks in an enclosure that has a misting means that provides saturation wetting on regular intervals during the curing process. Superior performance/utilization characteristics are achieved when tailing content does not exceed the 30% level.

It is further noted that if there are sufficient amounts of iron oxide in the mixture an aesthetically pleasing color is imparted to the mixture, very similar in shade to that of terra cotta. Further, the change in the pH of the aggregate, brought on by the addition of the acidic slurry, dramatically changes the “wetting” capabilities of the available water in the mixture. This results in a homogeneous crystalline structure of the concrete as it cures.

By using sulfuric acid as the primary reagent, and not removing the resulting salts that are formed from the neutralizing reaction that takes place, save for what is removed by separating the excess water from the slurry, the remaining sodium sulfate acts as a catalyst for the formation of the carbonatious crystals that characterize the internal crystalline structure of cementitious matrixes.

The method of the invention is illustrated by the following procedure: One part of bauxite tailings are suspended in three parts of water, a titration of the mixture is performed using one molar solution of sulphuric acid per mole of sodium in the tailings, until the mixture attains a pH 5.5-6.0. To successfully carry out the above, the mixture should be continuously agitated, keeping the particles of the mixture in suspension. Once the mixture has reached the desired pH of 5.5-6.0, the process is terminated. The mixture is then left to settle and the filtrate is separated from the supernatant fluid by decantation and/or filtration. The residue does not need to be washed. Evaporation of the supernatant fluid will yield sodium sulfate, which, once refined, can be sold as an industrial chemical or electrolyzed and recycled back into the process.

As a by-product of the foregoing preparation procedure of the tailings and subsequent incorporation into cementitious media, the finished product has enhanced efflorescence resistance, that is, above and beyond the resistance levels of concrete products not incorporating bauxite tailings as well as those that do.

According to the present invention, when sulfuric acid is the selected mineral acid, sodium is selectively extracted from the tailings into solution as sodium sulfate without contaminating the solution with the sulfates of iron, titanium, silicon or aluminum. The residual red mud from the above, free from sodium hydroxide, can now be used for the production of construction materials. Previously, the relatively high percent of soda in the bauxite tailings has rendered the above-mentioned unusable as a constituent of construction materials.

The following examples further illustrate embodiments of the invention.

### EXAMPLE 1

With 30% of the treated Red Mud added to a cementitious aggregate using only Portland cement as the binding agent, a concrete “paver” brick was formed, and cured to a dimension required to satisfy the aesthetic and structural requirements of the building industry and the consuming public. The resulting brick had the following characteristics:
a. Compressive strength of 2,750 p.s.i.
b. Water absorption: 13.5%.

### EXAMPLE 2

With 30% of the treated Red Mud added to a cementitious aggregate and with 30% of the Portland cement component replaced with the finely ground silicate tailings, a concrete “paver” brick can be formed, and cured to any dimension required to satisfy the aesthetic and structural requirements of the building industry and the consuming public. The resulting brick will have the enhanced characteristics:
c. Compressive strength: greater than 3,000 p.s.i.
d. Water absorption: less than 13.5%.

One face of a finished brick and, a “control” refractory brick from a kiln, were exposed at ambient temperature, to the 6800° F. heat of a high capacity Oxy/Acetylene “Rosebud” (large tip used expressly for heating wide areas of workpieces). The results were as follows: After 15 minutes of direct exposure to the flame, the brick of the invention was unchanged. After 5 minutes of the same treatment, the “control” brick's face had glazed and begun to melt and “drool” off as a liquid.

A common waste by-product of the Bayer process is a silicate rich component generally referred to as “sand” or “black sand”. The courser particles (the size of a grain of salt or larger) are generally separated out of the process stream before the “digestion” phase of the Bayer process.

This constituent is typically discarded, either separately or in suspension with the waste slurry. This material can also be utilized as an adjunct to, but is not essential for, the production of finished goods.

These naturally occurring silicates demonstrably enhance many of the curing and physical characteristics of the product of the invention. If these silicates are present in/at any given tailings site, they can be separated (if they aren't already) and ground to a fine powder consistency and added to the Portland cement as an enhancing agent to increase the strength and durability of the finished product. Optimal results are achieved when added to the Portland cement at a ratio of 30% silicates to 70% cement, however, improved product performance may be derived from just about any silicate proportion from about 5 to 50 percent. The “modified” Portland cement component is then admixed to a standard aggregate mixture along with the “stabilized red mud” of the present invention where water is added and the mixture is formed, vibrated and pressed to its finished shape and allowed to cure in a cool water saturated environment for at least 7 days. The maximum compression strength is reached by about the 28th day.

The process of the present invention employs a “cold process” for the stabilized bauxite, and as such, allows for a much broader spectrum of finished products. Roofing tiles, drainage tiles, floor tiles, paver bricks, revetment tiles, cinder blocks, retaining wall components, rail fences, sound barriers, privacy walls, jet blast deflection barriers, security walls, etc., basically anything that can be made of concrete can also be made with concrete and the stabilized tailings added to it.

The uses and applications of the invention are not limited to applications using concrete. The “stabilized tailings” of the invention can be used as filtration media, topsoil supplement, landfill capping, UV shielding in plastics, pigment for paint, plastics, ceramics and a non-polluting marker for surface water hydrology analysis.

Driveways or patios can be lined with it (it's cheap and durable enough) or Bar-B-Ques can be built with it (it's a refractory brick too). Roadside culverts can be lined with it or river revetments (because it has excellent efflorescence resistance) or the walls of a pig-iron smelter can be lined with it. Also, by adding the stabilized tailings of the invention to standard Portland Cement it can then be used as an inexpensive and durable mortar for refractory brick emplacements.

It will be apparent to those skilled in the art that various modifications and variations can be made in the process and product of the present invention without departing from the spirit or scope thereof. Thus, it is intended that the present invention cover modifications and variations thereof provided they fall within the scope of the appended claims and their equivalents.

1. A process for treating waste streams containing bauxite tailings to substantially neutralize a predominant proportion of alkaline compounds present therein, comprising:
pulverizing said bauxite tailings into a generally homogenous powder;
agitating said powder while adding sufficient water to form a generally free flowing slurry;
adding sufficient acid to the slurry to neutralize said alkaline compounds to a pH of about 5.5 to 6 to form water and an aqueous solution of the salts of said acid; and
separating said aqueous salt solution from remaining insoluble slurry material.

2. The process of claim 1 wherein said homogenous powder is sufficiently fine to generally pass through a 16 mesh screen.

3. The process of claim 1 wherein said alkaline compound is sodium hydroxide.

4. The process of claim 1 wherein said acid is a mineral acid.

5. The process of claim 4 wherein said mineral acid is sulfuric acid.

6. The process of claim 1 wherein said insoluble slurry materials from the treated, bauxite tailings containing waste stream are further treated to form a component of building material.

7. The process of claim 1 wherein at least a portion of said salt remains with said insoluble slurry material after removal of water therefrom.

8. The process of claim 6 wherein said building material is cementitious.

9. The process of claim 8 wherein said cementitious building material is a brick.

10. A structural building material comprising a cured, molded component comprising cementitious material, aggregate and up to about 30% by volume pulverized bauxite tailings which have been treated with sufficient aqueous mineral acid to substantially neutralize alkaline compounds present in said tailings.

11. The building material of claim 10 wherein said molded component is a brick.

12. The building material of claim 10 wherein said mineral acid is sulfuric acid.

13. The building material of claim 10 wherein said alkaline compound is sodium hydroxide.

14. The structural building material of claim 10 wherein said aggregate is a silicate containing component in an amount of about 5 to 50 percent relative to the weight of the cementitious material.

15. The structural building material of claim 10 wherein said cementitious material is cement.

16. A process for treating bauxite tailings comprising:
pulverizing said bauxite tailings into a generally homogenous powder;
agitating said powder while adding sufficient water to form a generally free flowing slurry; and
adding sufficient acid to said slurry to substantially neutralize alkaline values present therein to form water and salts of said values.

17. The process of claim 16 which further includes separating said salts from remaining insoluble slurry material.

18. The process of claim 17 wherein said insoluble slurry material is combined with cementitious material, compacted and cured to form a brick.

19. The process of claim 16 wherein said alkaline values are alkali metal hydroxides and said acid is a mineral acid.

20. The process of claim 16 wherein said neutralization is to a pH of about 5.5 to 6.

21. A process for forming a cementitious material containing treated bauxite tailings comprising:
pulverizing bauxite tailings containing alkaline compounds into a generally homogeneous powder;
agitating said powder while adding sufficient water to form a generally free flowing slurry;
adding sufficient acid to the slurry to neutralize said alkaline compounds to a pH of about 5.5 to 6 to form water and an aqueous solution of the salts of said acid;
separating said aqueous salt solution from remaining insoluble slurry material; and
combining said insoluble slurry material in an amount of from about 5 to 50 percent by volume with a cementitious substance to form said cementitious material.

22. The process of claim 21 wherein said cementitious substance is cement.

23. The process of claim 21 wherein said insoluble slurry is combined with said cementitious substance, compacted and cured to form a brick.

24. The process of claim 23 wherein said brick is cured in a super saturated humidity environment for a predetermined time period.

25. The process of claim 24 wherein said time period is at least 168 hours.

26. The process of claim 21 wherein said acid is sulfuric acid and at least a portion of the said salts of the sulfuric acid that are formed remain with the insoluble slurry material after removal of water therefrom to catalyze subsequent formation of carbonaceous crystals in the cementitious material.

27. The process of claim 26 wherein said insoluble slurry material is not washed subsequent to separating the aqueous salt solution.

28. The process of claim 5 wherein said insoluble slurry material is not washed subsequent to separating the aqueous salt solution.
